(19) United States
(12) Patent Application Publication
(10) Pub. No.: US 2021/0312282 A1
(43) Pub. Date: Oct. 7, 2021

(54) SYSTEM AND METHOD FOR FACILITATING EXPLAINABILITY IN REINFORCEMENT MACHINE LEARNING

(71) Applicant: ROYAL BANK OF CANADA, Toronto (CA)

(72) Inventors: Pablo Francisco HERNANDEZ LEAL, Edmonton (CA); Ruitong HUANG, Toronto (CA); Bilal KARTAL, Edmonton (CA); Changjian LI, Edmonton (CA); Matthew Edmund TAYLOR, Edmonton (CA); Alexander BRANDIMARTE, Toronto (CA); Pui Shing LAM, Toronto (CA)

(21) Appl. No.: 17/220,019

(22) Filed: Apr. 1, 2021

Related U.S. Application Data
(60) Provisional application No. 63/162,276, filed on Mar. 17, 2021.
(60) Provisional application No. 63/003,484, filed on Apr. 1, 2020.

(51) Int. Cl. G06N 3/08; G06K 9/62

(52) U.S. Cl. CPC G06N 3/08; G06K 9/6215; G06K 9/6296; G06K 9/6263; G06K 9/6256

(57) ABSTRACT

Systems are methods are provided for facilitating explainability of decision-making by reinforcement learning agents. A reinforcement learning agent is instantiated which generates, via a function approximation representation, learned outputs governing its decision-making. Data records of a plurality of past inputs for the agent are stored, each of the past inputs including values of a plurality of state variables. Data records of a plurality of past learned outputs of the agent are also stored. A group definition data structure defining groups of the state variables are received. For a given past input a given group, data generated reflective of a perturbed input by altering a value of at least one state variable is generated, and are presented to the reinforcement learning agent to obtain a perturbed learned output generated by the reinforcement learning agent; and a distance metric is generated reflective of a magnitude of difference between the perturbed learned output and the past learned output.

### CROSS-REFERENCES TO RELATED APPLICATIONS

This application claims all benefit including priority to U.S. Provisional Patent Application No. 63/003,484 filed on Apr. 1, 2020, and U.S. Provisional Patent Application No. filed on Mar. 17, 2021, each entitled “SYSTEM AND METHOD FOR FACILITATING EXPLAINABILITY IN REINFORCEMENT MACHINE LEARNING”, and the contents of each of which are hereby incorporated by reference.

### FIELD

The present disclosure generally relates to the field of computer processing and reinforcement learning.

### BACKGROUND

Reinforcement learning systems are often viewed as black boxes, and there is limited ability to explain how such systems make decisions. Accordingly, it may be difficult to understand or trust such systems.

### SUMMARY

In accordance with an aspect, there is provided a computer-implemented system for facilitating explainability of decision-making by reinforcement learning agents. The system includes at least one processor; memory in communication with the at least one processor; and software code stored in the memory. The software code, when executed at the at least one processor causes the system to: instantiate a reinforcement learning agent that generates, via a function approximation representation, learned outputs governing its decision-making; store data records of a plurality of past inputs presented to the reinforcement learning agent, each of the past inputs including values of a plurality of state variables, and data records of a plurality of past learned outputs, each of the past learned outputs generated by the reinforcement learning agent when presented with a corresponding one of the past inputs; receive a group definition data structure defining a plurality of groups of the state variables; and for a given past input of the plurality of past inputs and a given group of plurality of groups of the state variables: generate data reflective of a perturbed input by altering a value of at least one state variable in the given group in the given past input; present the data reflective of the perturbed input to the reinforcement learning agent to obtain a perturbed learned output generated by the reinforcement learning agent; and generate a distance metric reflective of a magnitude of difference between the perturbed learned output and the past learned output.

In accordance with another aspect, there is provided a computer-implemented method for facilitating explainability of decision-making by reinforcement learning agents. The method includes instantiating a reinforcement learning agent that generates, via a function approximation representation, learned outputs governing its decision-making; storing data records of a plurality of past inputs presented to the reinforcement learning agent, each of the past inputs including values of a plurality of state variables, and data records of a plurality of past learned outputs, each of the past learned outputs generated by the reinforcement learning agent when presented with a corresponding one of the past inputs; receiving a group definition data structure defining a plurality of groups of the state variables; and for a given past input of the plurality of past inputs and a given group of plurality of groups of the state variables: generating data reflective of a perturbed input by altering a value of at least one state variable in the given group in the given past input; presenting the data reflective of the perturbed input to the reinforcement learning agent to obtain a perturbed learned output generated by the reinforcement learning agent; and generating a distance metric reflective of a magnitude of difference between the perturbed learned output and the past learned output.

Many further features and combinations thereof concerning embodiments described herein will appear to those skilled in the art following a reading of the instant disclosure.

### DESCRIPTION OF THE FIGURES

In the figures, which illustrate example embodiments,

FIG. 1 is a schematic diagram of a computer-implemented system for training an automated agent, in accordance with an embodiment;

FIG. 2A is a schematic diagram of an automated agent of the system of FIG. 1, in accordance with an embodiment;

FIG. 2B is a schematic diagram of an example neural network, in accordance with an embodiment;

FIG. 3 is a schematic diagram of an explainability subsystem of the system of FIG. 1, in accordance with an embodiment;

FIG. 4A is a graph of an example histogram and obtained k-means, in accordance with an embodiment;

FIG. 4B is a graph showing example elbow selection, in accordance with an embodiment;

FIG. 5 is a graph of an example histogram and obtained modes, in accordance with an embodiment;

FIG. 6A and FIG. 6B are schematic diagrams of example use of imputation models, in accordance with an embodiment;

FIG. 7A is an example image represented by input data;

FIG. 7B, FIG. 7C, FIG. 7D, and FIG. 7E are each example images represented by the input data of FIG. 7A, as perturbed, in accordance with an embodiment;

FIG. 8A is an example screen from a lunar lander game;

FIG. 8B is a graph of an example distribution for a state variable of the lunar lander game of FIG. 8A, in accordance with an embodiment;

FIG. 9A depicts an orientation definition for an angle state variable of the lunar lander game of FIG. 8A, in accordance with an embodiment;

FIG. 9B is a graph of an example distribution for the state variable of FIG. 9A, in accordance with an embodiment;

FIG. 10A and FIG. 10B each depict groupings for possible values of example state variables, in accordance with an embodiment;

FIG. 11 is an example graphical representation generated by the explainability subsystem of FIG. 3, in accordance with an embodiment;

FIG. 12 is a flowchart showing example operation of the explainability subsystem of FIG. 3, in accordance with an embodiment;

FIG. 13 illustrates an example user interface (UI) generated by the explainability subsystem of FIG. 3, in accordance with an embodiment;

FIG. 14 illustrates an example UI element generated by the explainability subsystem of FIG. 3, in accordance with an embodiment; and

FIG. 15 illustrates example logic implemented by the explainability subsystem of FIG. 3, in accordance with an embodiment.

### DETAILED DESCRIPTION

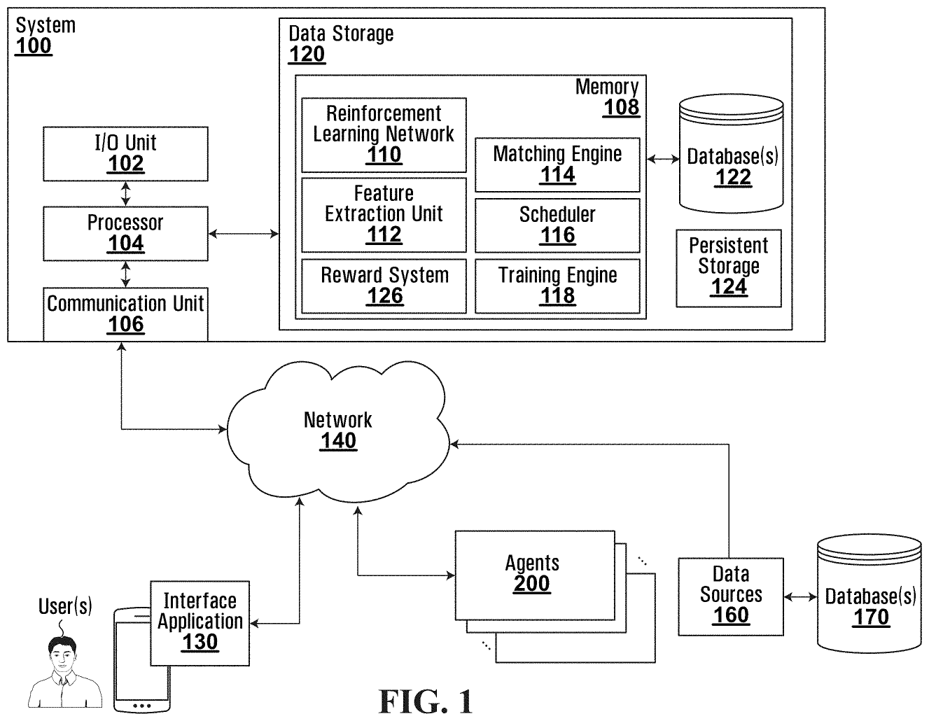

FIG. 1 is a high-level schematic diagram of a computer-implemented system 100 for instantiating and training automated agents 200 having a reinforcement learning neural network, in accordance with an embodiment.

In various embodiments, system 100 is adapted to perform certain specialized purposes. In some embodiments, system 100 is adapted to instantiate and train automated agents 200 for playing a video game. In other embodiments, system 100 is adapted to instantiate and train automated agents 200 to generate requests to be performed in relation to securities (e.g., stocks, bonds, options or other negotiable financial instruments). For example, automated agent 200 may generate requests to trade (e.g., buy and/or sell) securities by way of a trading venue. In yet other embodiments, system 100 is adapted to instantiate and train automated agents 200 for performing image recognition tasks. As will be appreciated, system 100 is adaptable to instantiate and train automated agents 200 for a wide range of purposes and to complete a wide range of tasks.

Once an automated agent 200 has been trained, it generates output data reflective of its decisions to take particular actions in response to particular input data. Input data include, for example, values of a plurality of state variables relating to an environment being explored by an automated agent 200 or a task being performed by an automated agent 200. In some cases, one or more state variables may be one-dimensional. In some cases, one or more state variables may be multi-dimensional. A state variable may also be referred to as a feature. The mapping of input data to output data may be referred to as a policy, and governs decision-making of an automated agent 200. A policy may, for example, include a probability distribution of particular actions given particular values of state variables at a given time step.

For automated agents 200 that generate policies using a reinforcement learning neural network, there is limited visibility into the mapping of input data to output data, and thus limited ability to understand how decisions are made. Thus, there is a need for technologies such as disclosed herein to facilitate explainability of decision-making by such automated agents.

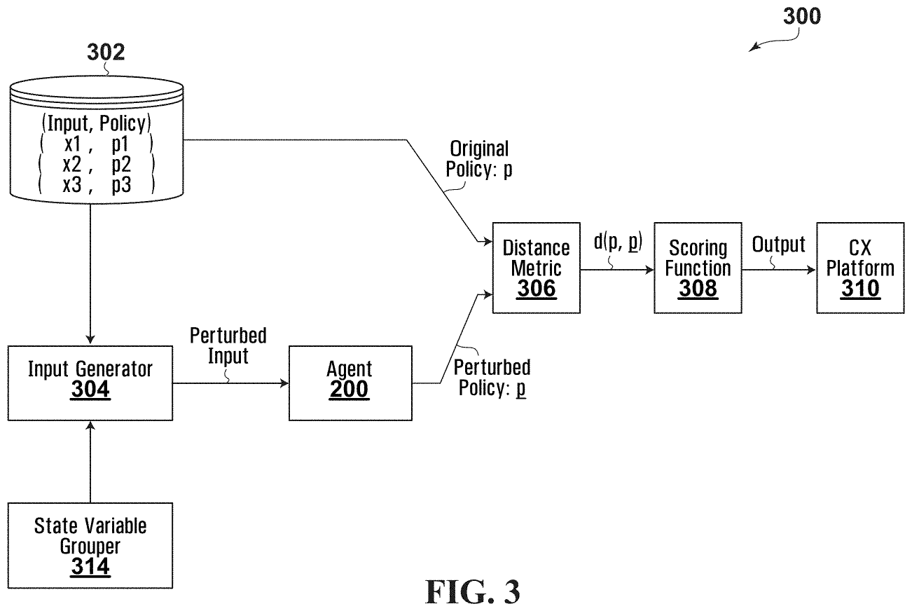

To this end, FIG. 3 is a high-level schematic diagram of an explainability subsystem 300, in accordance with an embodiment. Explainability subsystem 300 may be implemented at system 100 to facilitate explainability of decision-making by automated agents 200 trained by system 100. In various embodiments, facilitating explainability may include, for example, providing data such as metrics or scores that assist in answering why an automated agent 200 has made a certain decision, what inputs play important roles in that decision, and/or how inputs could be changed to cause an automated agent 200 to make a different decision.

In some embodiments, use of embodiments of explainability subsystem 300 may, for example, improve an ability to debug an automated agent 200, to debug reinforcement learning algorithms used for training, and/or to improve the speed at which automated agents 200 are trained. In some embodiments, use of embodiments of explainability subsystem 300 may also, for example, improve trustworthiness of system 100, improve acceptance of particular reinforcement learning algorithms implemented at system 100, and/or improve accountability of automated agents 200.

Referring again to the embodiment depicted in FIG. 1, system 100 includes an I/O unit 102, a processor 104, a communication interface 106, and a data storage 120.

I/O unit 102 enables system 100 to interconnect with one or more input devices, such as a keyboard, mouse, camera, touch screen and a microphone, and/or with one or more output devices such as a display screen and a speaker.

Processor 104 executes instructions stored in memory 108 to implement aspects of processes described herein. For example, processor 104 may execute instructions in memory 108 to configure a data collection unit, interface unit (to provide control commands to interface application 130), reinforcement learning network 110, feature extraction unit 112, matching engine 114, scheduler 116, training engine 118, reward system 126, and other functions described herein. Processor 104 can be, for example, various types of general-purpose microprocessor or microcontroller, a digital signal processing (DSP) processor, an integrated circuit, a field programmable gate array (FPGA), a reconfigurable processor, or any combination thereof.

Communication interface 106 enables system 100 to communicate with other components, to exchange data with other components, to access and connect to network resources, to serve applications, and perform other computing applications by connecting to a network 140 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi or WiMAX), SS7 signaling work, fixed line, local area network, wide area network, and others, including any combination of these.

Data storage 120 can include memory 108, databases 122, and persistent storage 124. Data storage 120 may be configured to store information associated with or created by the components in memory 108 and may also include machine executable instructions. Persistent storage 124 implements one or more of various types of storage technologies, such as solid state drives, hard disk drives, flash memory, and may be stored in various formats, such as relational databases, non-relational databases, flat files, spreadsheets, extended markup files, etc.

Data storage 120 stores a model for a reinforcement learning neural network. The model is used by system 100 to instantiate one or more automated agents 200 that each maintain a reinforcement learning neural network 110 (which may also be referred to as a reinforcement learning network 110 or a network 110 for convenience). Automated agents may be referred to herein as reinforcement learning agents, and each automated agent may be referred to herein as a reinforcement learning agent.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

System 100 may connect to an interface application 130 installed on a user device to receive input data. The interface unit 130 interacts with the system 100 to exchange data (including control commands) and generates visual elements for display at the user device. The visual elements can represent reinforcement learning networks 110 and output generated by reinforcement learning networks 110.

System 100 may be operable to register and authenticate users (using a login, unique identifier, and password for example) prior to providing access to applications, a local network, network resources, other networks and network security devices.

System 100 may connect to different data sources 160 and databases 170 to store and retrieve input data and output data.

Processor 104 is configured to execute machine executable instructions (which may be stored in memory 108) to instantiate an automated agent 200 that maintains a reinforcement learning neural network 110, and to train reinforcement learning network 110 of automated agent 200 using training unit 118. Training unit 118 may implement various reinforcement learning algorithms known to those of ordinary skill in the art.

Processor 104 is configured to execute machine-executable instructions (which may be stored in memory 108) to train a reinforcement learning network 110 using reward system 126.

Reward system 126 generates positive signals and/or negative signals to train automated agents 200 to perform desired tasks more optimally, e.g., to minimize and maximize certain performance metrics. A trained reinforcement learning network 110 may be provisioned to one or more automated agents 200.

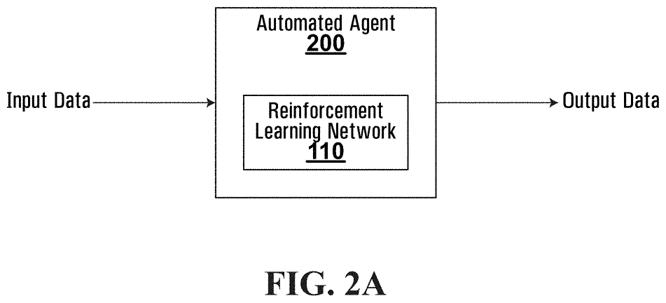

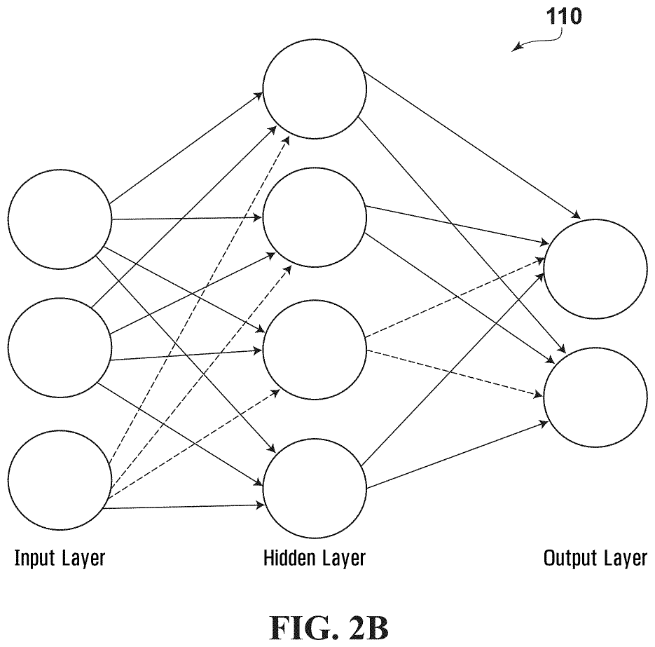

As depicted in FIG. 2A, automated agent 200 receives input data (via a data collection unit, not shown) and generates output data according to its reinforcement learning network 110. Automated agents 200 may interact with system 100 to receive input data and provide output data.

FIG. 2B is a schematic diagram of an example neural network 110, in accordance with an embodiment. The example neural network 110 can include an input layer, a hidden layer, and an output layer. The neural network 110 processes input data using its layers based on reinforcement learning, for example.

Referring again to FIG. 3, explainability subsystem 300 includes a database 302, an input generator 304, a policy distance calculator 306, a scorer 308, and an output visualizer 310. As detailed below, explainability subsystem 300 presents perturbed input data to an automated agent 200 instantiated by system 100, and obtains the policies generated by the automated agent 200 in response to the perturbed input data. By controlling how perturbed input data are created, e.g., by changing values of a subset of state variables of the input data at a time, the impact of such changes on the agent's policy can be measured. As detailed herein, in some embodiments, a subset of state variables may correspond to a group of related state variables. So, perturbed input data may be created by changing values of a group of related state variables. State variables may be determined to be related, for example, based on calculating a correlation metric.

In the depicted embodiment, explainability subsystem 300 is implemented at system 100. Accordingly, system 100 stores in memory 108 executable code for implementing the functionality of subsystem 300, for execution at processor 104. In other embodiments, subsystem 300 may be implemented separately from system 100, e.g., at a separate computing device. Subsystem 300 may send data to automated agents 200 (e.g., perturbed input data) and receive data from automated agents 200 (e.g., perturbed policy data), by way of network 140.

Database 302 stores data pairs, where each pair incudes data reflective of a past input presented to an automated agent 200 and data reflective of a past policy adopted by the agent 200 in response to the past input. In particular, database 302 stores data records of a plurality of past inputs presented to an automated agent 200, where each of the past inputs includes values of a plurality of state variables, and also stores corresponding data records of a plurality of past policies, each of the past policies generated by the automated agent 200 when presented with a corresponding one of the past inputs. In some embodiments, database 302 may store data pairs for a single past time step of automated agent 200. In some embodiments, database 302 may store data pairs for multiple past time steps of automated agent 200. Database 302 may be stored in data storage 120 of system 100.

Input generator 304 generates perturbed input data to be presented to an automated agent 200. Perturbed input data may be generated by processing past input data and replacing a subset of the state variables with another value such as a default value. A default value may also be referred to as a baseline value.

Various ways of selecting such other values are possible. In one example, the value may be selected to be a minimum value or a maximum value. In another example, the value may be selected to be a value that reflects a central value of a distribution such as a mean, a median, or a mode value. In another example, the value may be selected to be a modified past value such as a past value with noise added, or a past value with a certain function applied to it. In another example, the value may be selected to be a predicted future value.

An appropriate default value may depend on the distribution of the state variable. For instance, if the distribution is Gaussian, the mean of the distribution may be selected as a default value. However, for some non-Gaussian distributions, the mode may be a more preferred selection for a default value.

An appropriate default value may also depend on the type of the state variable, e.g., whether it is a continuous state variable, a categorical state variable, or a Boolean state variable. In the case of a Boolean state variable, a possible choice for a default value may be the most common value (e.g., either true or false).

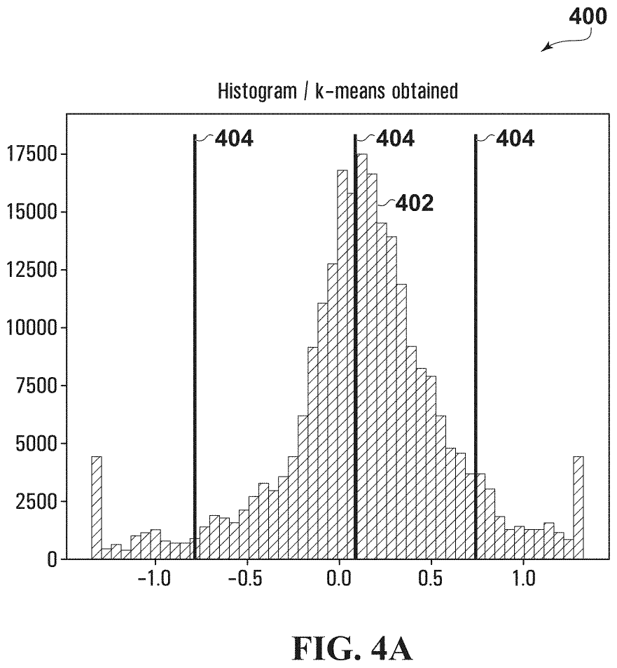

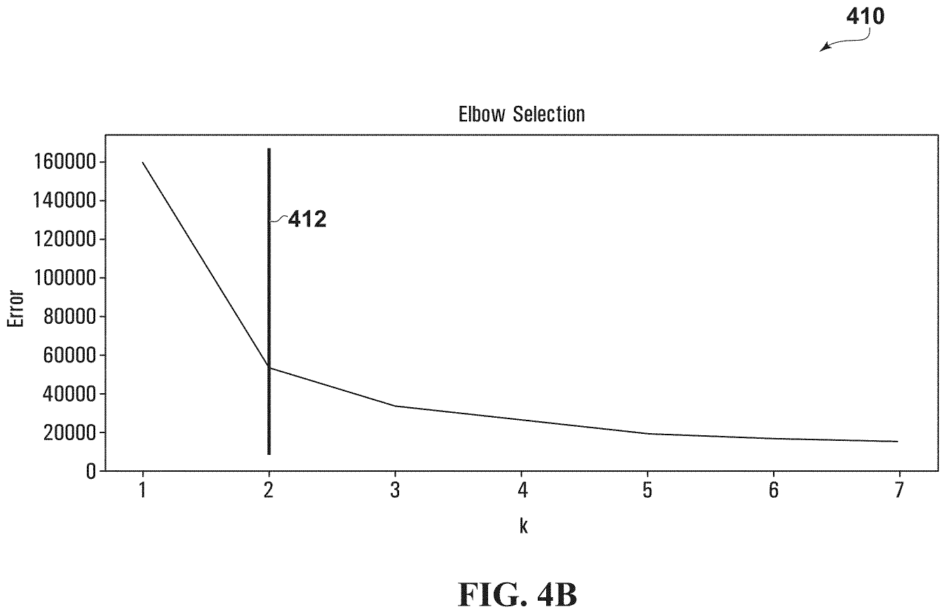

In some embodiments, default values for a state variable may be determined using a k-means algorithm. In particular, k default values can be determined as the k centers of a distribution of that state variable. FIG. 4A depicts a histogram 402 of a distribution of an example state variable. As shown, the distribution is not Gaussian. A k-means algorithm (with k=3) can be used to determine three centers 404. These three centers define a set of possible default values.

In some embodiments, the value of k for a k-means algorithm is pre-defined. In some embodiments, the value of k may be selected automatically for a state variable. For example, the so-called elbow method may be used to select automatically the value of k. The elbow method tries different values of k and computes an associated error value, which measures how similar the data in each cluster are. FIG. 4B depicts an example graph of this error value as a function of k. As shown, the graph includes a downward-sloping curve with the error decreasing as the number of clusters increases. The elbow method identifies a point in the curve where the maximum curvature is obtained; in other words, it looks for the “elbow” of the curve. Maximum curvature is found where the curve differs most from the straight line segment connecting the first and last data point. The value of k at the elbow is used for the k-means algorithm. In the example shown in FIG. 4B, the value of k is selected to be 2, corresponding to the location of elbow 412.

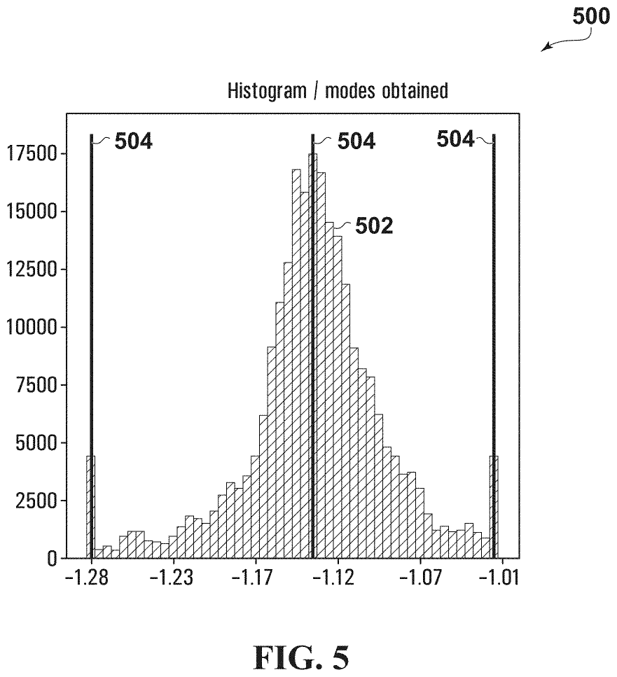

In some embodiments, default values for a state variable may be determined using a mode-seeking or mode-learning algorithm. For example, modes may be determined using a mean-shift method. FIG. 5 depicts a histogram 502 of a distribution of an example state variable. As shown, the distribution is not Gaussian. The mean-shift method may be used to determine three modes 502. These three modes define a set of possible default values.

In some embodiments, default values for a state variable may be determined using imputation models. In contrast to embodiments in which default values for a state variable can be found without reference to other state variables (e.g., k-means or mean-shift), an imputation model imputes the value of at least one particular state variable of a group of related state variables using a conditional distribution of the particular state variable(s) given the values of other state variables, e.g., in other groups. In some cases, an imputation model can impute the value of each state variable of a group of related state variables using a conditional distribution of the particular state variables given the values of other state variables, e.g., in other groups.

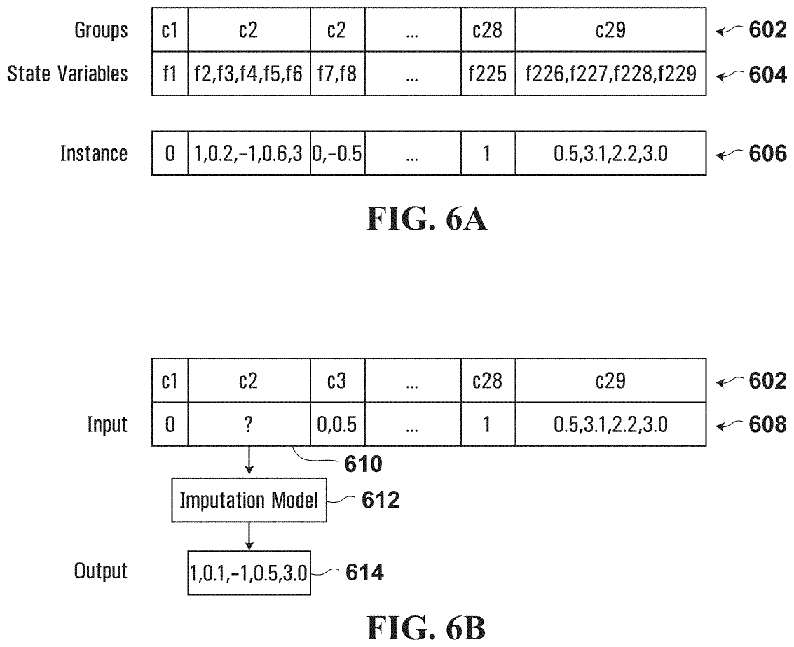

FIG. 6A and FIG. 6B schematically illustrate the use of imputation models to generate default values. As shown in FIG. 6A, in this example, there are twenty-nine (29) groups 602 of related state variables (i.e., groups c1 through c29), with each group having one or more state variables 604 (i.e., state variables f1 through f229). In an embodiment, a plurality of imputation models is generated, one for each group of related state variables. Each imputation model is trained to predict the values of state variables in a group of state variables using as input the values 606 of other state variables. In the depicted embodiment, supervised training is used to train an imputation model, but in other embodiments, unsupervised training may be used. In the depicted embodiment, an imputation model is implemented as a linear model, but in other embodiments, a non-linear model (e.g., a neural network) may be used. FIG. 6B depicts an imputation model 612 for group c2 used to generate default values 614 too replace values 610 of state variables in group c2. The input to imputation model 612 are values 608 of state variables in other groups.

In some embodiments, default values or data used to calculate default values may be re-determined from time to time, e.g., periodically. This allows default values to follow potential changes in state variable distributions over time. For example, a default value of a state variable may re-determined once a day, once a week, or the like. This may include, for example, re-calculating means, modes, other centers, or the like. For example, in an embodiment, the k-means algorithm may be executed periodically to recalculate mean values.

Input generator 302 may be further explained with reference to an automated agent 200 trained for image recognition, e.g., recognizing cats in images. In this example, each state variable may be a pixel value in an image. Groups of state variables correspond to groups of correlated pixels, each group representative of a different part of a cat, such as a face, a limb, a body, or a tail.

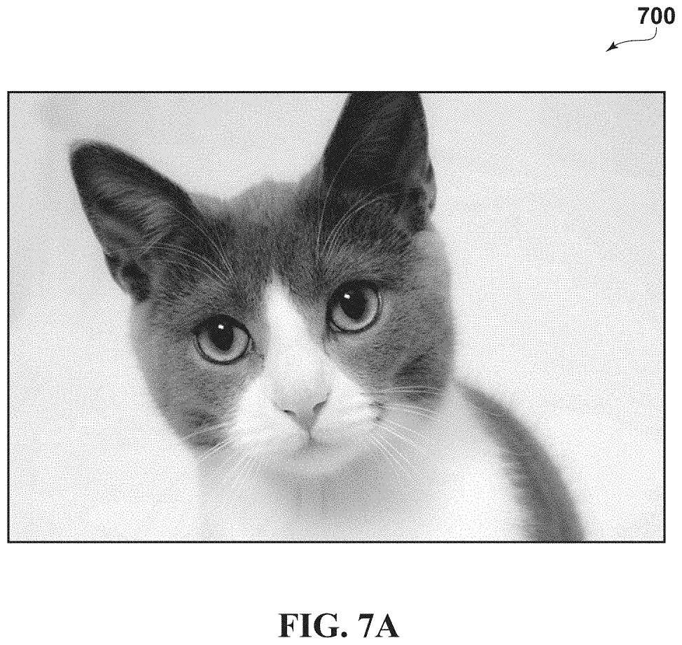

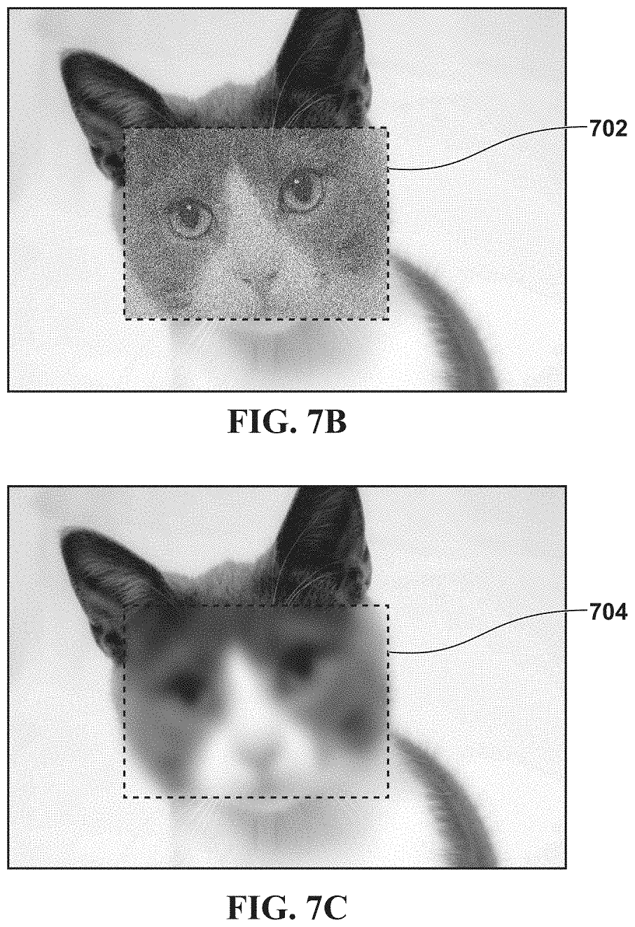

FIG. 7A shows example past input data; in this example, the past input data is image data defining an image 700. Each pixel corresponds to a state variable. FIG. 7B shows example perturbed data in which a subset 702 of the state variables, i.e., a subset of the pixels, has been changed to reflect addition of noise. FIG. 7C shows example perturbed data in which a subset 704 of pixels has been changed to reflect a blurring function being applied. FIG. 7D shows example perturbed data in which a subset 706 of pixels has been changed to a minimum value (e.g., black pixels). FIG. 7E shows example perturbed data in which a subset 708 of pixels has been changed to a maximum value (e.g., white pixels).

In some embodiments, it may be desirable to select a default value that is a realistic value for a given state variable. This may, for example, avoid providing automated agent 200 with perturbed input data that has unrealistic values, which may generate perturbed policies that are likewise unrealistic or otherwise do not facilitate explainability of the agent's decision making. In such embodiments, for example, it may be preferred to replace state variables with values that reflect recorded past data with noise added or a filter applied (e.g., as shown in FIG. 7B or FIG. 7C), rather than a value that is unlikely to appear in real input data such as a maximum value or a minimum value (e.g., as shown in FIG. 7D or FIG. 7E).

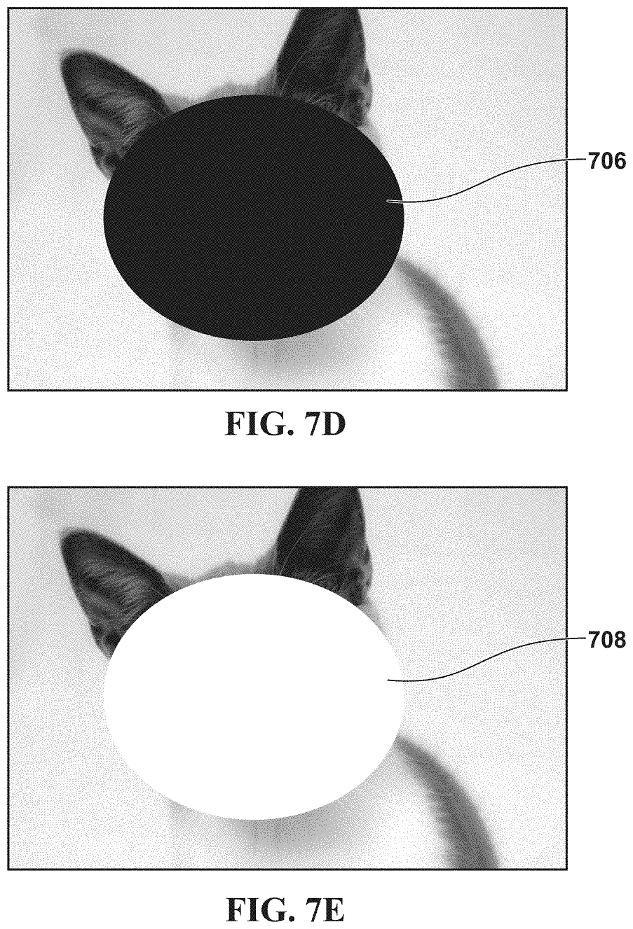

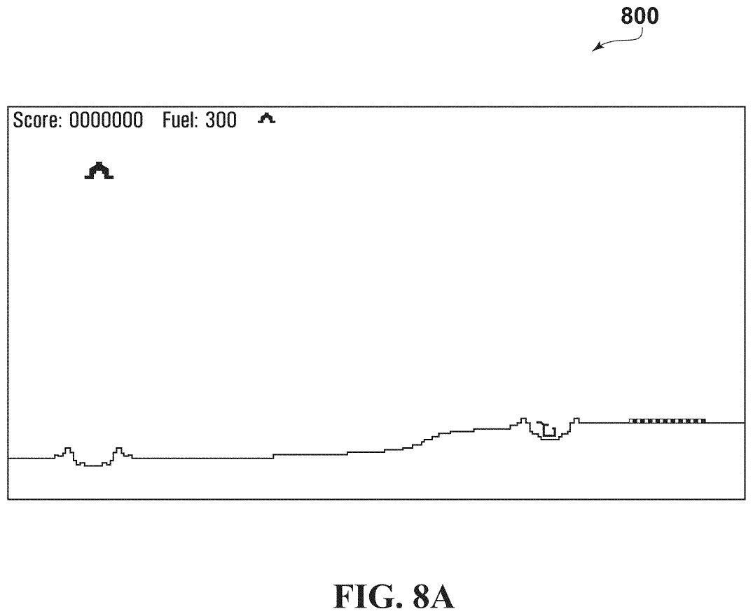

Input generator 302 may be further described with reference to an automated agent 200 trained to play a video game, and more specifically, a lunar lander game, as shown in FIG. 8A. In this game, the goal is to control the lander's two thrusters so that it quickly, but gently, settles on a target landing pad. In this example, state variables provided as input to an automated agent 200 may include, for example, X-position on the screen, Y-position on the screen, altitude (distance between the lander and the ground below it), vertical velocity, horizontal velocity, angle of the lander, whether lander is touching the ground (Boolean variable), etc.

In order to measure the relative importance of these different state variables, their values could be changed one at a time, e.g., replaced with some other value such as a default value.

However, some state variables may be related. For example, consider what happens when the input values of the state variables altitude and y position are changed. For instance, if the altitude is changed but the y position is unchanged, automated agent 200 may not execute a different action because it focuses on the y position. Similarly, if the y position is changed but the altitude is unchanged, automated agent 200 may not execute a different action because it focuses on the altitude. In another example, consider if the input included readings from two altitude sensors which always read the same value. In this example, modifying one sensor reading without modifying the other sensor reading would not facilitate a useful estimate of the input's impact on the automated agent's policy.

Accordingly, related state variables should be changed as a group. To this end, input generator 304 receives a group definition data structure defining a plurality of groups of state variables. This group definition data structure may be stored, for example, in database 302. In some embodiments, groups may be defined automatically, e.g., by a state variable grouper 314 described below. In some embodiments, groups may be defined manually. In some embodiments, each state variable may be grouped into one group only. In some embodiments, at least one of the state variables may be grouped into multiple groups.

Each such group of related state variables may be referred to herein as a “factor”. Accordingly, it can be said that input generator 302 perturbs factors rather than individual state variables, though it is possible that a factor contains only one state variable. A group of related state variables may also be referred to herein as a cluster of state variables.

The group definition data structure may include a human-readable descriptor for each group of state variables, the descriptor providing a description of that group. In some embodiments, this descriptor may be generated automatically, e.g., through natural language generation. In some embodiments, this descriptor may be generated manually.

In the Lunar Lander example, input generator 304 may receive a group definition data structure defining the following plurality of groups of state variables:

Group 1: X-position, horizontal velocity;

Group 2: Y-position, altitude, vertical velocity; and

Group 3: Angle of the lander, angular velocity.

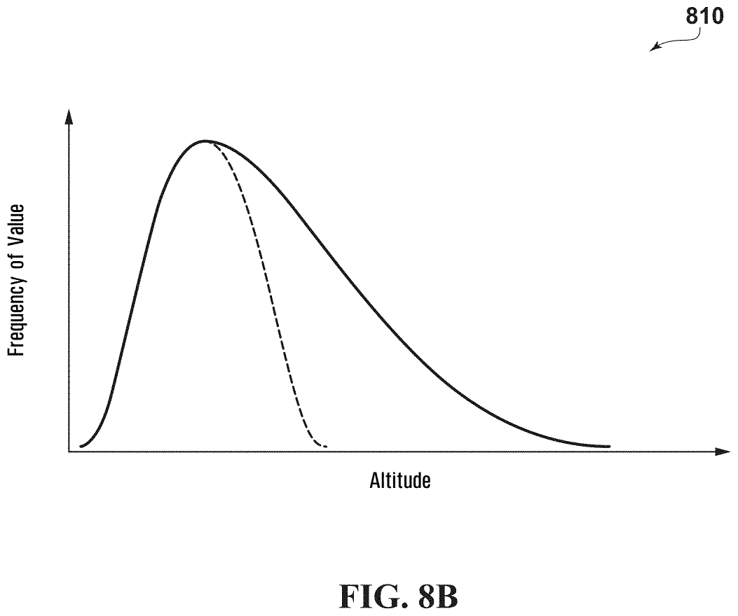

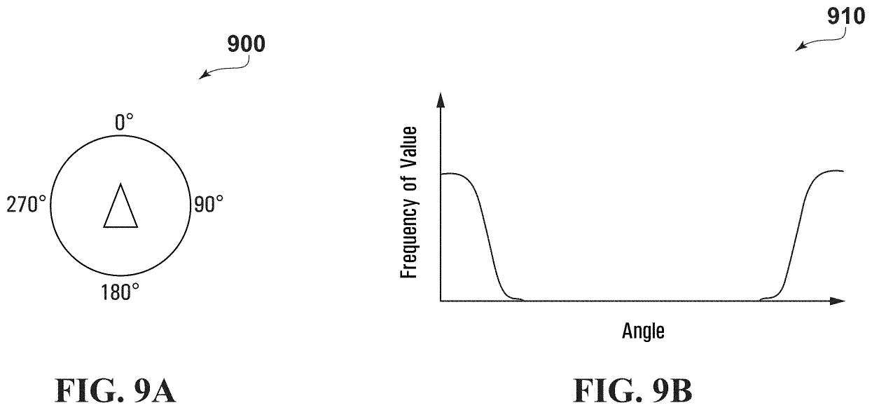

As noted above, perturbing input data includes replacing the values of certain state variables with default values. For some state variables, the appropriate default value may depend on the state variable's distribution. Consider a distribution 810 of the altitude state variable as shown in FIG. 8B. Because the lander spends more time near to the ground, the mode of the distribution may be a more appropriate default value instead of the mean of the distribution. Consider also the distribution 910 of state variable of the angle of the lander as shown in FIG. 9B. As shown in legend 900 of FIG. 9A, the angle of the lander can be defined such that 0 degrees is perfectly vertical. Then, because the majority of the time the lander will be near vertical, the distribution will be bi-modal (with two peaks), as shown in FIG. 9B. Thus appropriate default values for the angle may be selected from near either peak, e.g., such as 5 degrees and 355 degrees. In contrast, the average value of 180 degrees would never be seen, and thus may be an inappropriate default value.

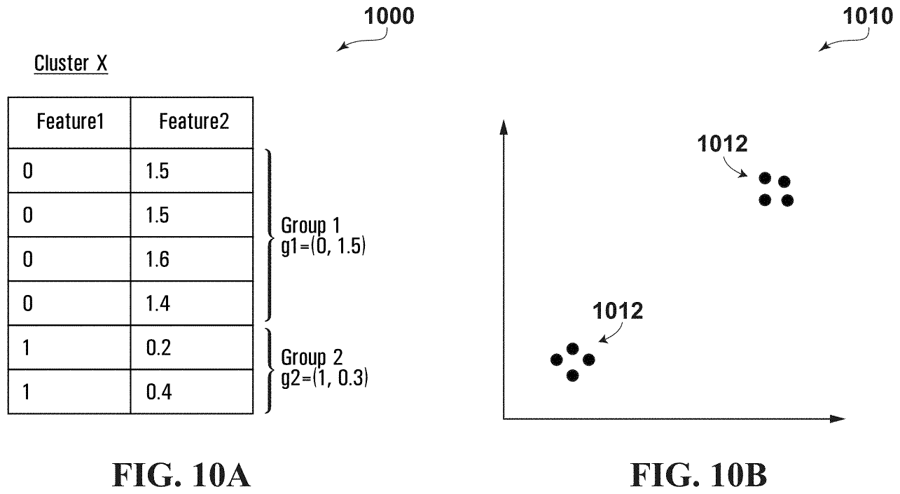

In some cases, selection of an appropriate default value includes consideration of the relationships between state variables in a given group (i.e., in a given factor). For example, in such cases, default values are selected based on realistic values across state variables in a given group. Consider two state variables, namely, Feature1 and Feature2 as shown in FIG. 10A. Past input data shows that for these two state variables, values appear in two clusters, namely, Group 1 and Group 2. Each cluster may correspond for example, to one of the possible default values generated via mode seeking or via k-means.

Default values for Feature1 and Feature2 are selected in tandem, from either Group 1 or Group 2. For example, from Group 1, an appropriate default value might be the mean values from Group 2, i.e., Feature1=0, Feature2=1.5; and from Group 2, an appropriate default value might be the mean values from Group 2, i.e., Feature1=1 and Feature2=0.3. Selection of realistic values across state variables is further illustrated in FIG. 10B, which shows a plot of past values of a first state variable along the x-axis, against past values of a second state variable along the y-axis. As shown, for these two state variables, past values are also found in two clusters, and appropriate default values should be selected from one of these clusters. As will be appreciated, although the relationships between state variables is shown across two dimensions in this example, in other cases, the relationships may span n-dimensions.

When multiple default values are possible (e.g., in the case of multiple clusters of values are shown in FIG. 10A) or multiple possible values as provided by a k-means or a mode-seeking algorithm, each of the default values may be used to perturbed input data, and an average change caused by the default values to the perturbed policy can be determined. In some embodiments, the change may be obtained as a weighted average, where the weight is based on the size of cluster of values. With reference to the example shown in FIG. 10A, Group 1 has four instances while Group 2 has two instances. Thus, a weighted average approach would give a weight of 4/6 to Group 1 and a weight of 2/6 to Group 2 when determining a weighted average change to the perturbed policy.

When multiple default values are possible, some of the default values may be far away from the current input value of the state variable being observed by an automated agent 200. In some embodiments, the default value used as perturbed input may be selected as the possible default value that is closest to the current input.

Input generator 304 presents data reflective of the perturbed input to automated agent 200. Using this perturbed input, automated agent 200 generates data reflective of a perturbed policy.

Policy distance calculator 306 receives the perturbed policy generated by automated agent 200 in response to the perturbed input, and also receives the past policy corresponding to the past (unperturbed) input in a data pair noticed above. Policy distance calculator 306 generates a distance metric reflective of a magnitude of difference between the perturbed policy and the past policy. This distance metric reflects how much the policy changes as a result of perturbing a group of state variables (i.e., a factor), and thus provides an indication of the relative importance of the factor.

For example, returning to the lunar lander example, in a given case, the distance metrics calculated by policy distance calculator 306 may show that the factor corresponding to the Group 2 state variables (i.e., Y-position, altitude, and vertical velocity) is the most important factor for decision-making by an automated agent 200. This may be reported to a human operator of system 100, e.g., by way of a graphical representation generated by output visualizer 310, to help that operator understand how automated agent 200 made certain decisions. In some embodiments, this may increase transparency and trust in automated agent 200.

In some embodiments, policy distance calculator 306 generates a distance metric by calculating an alpha divergence metric, which may also be referred to as a Rényi divergence metric. Conveniently, calculation of an alpha divergence metric provides a tunable alpha parameter, which may, for example, be tuned to smoothen measurements of policy changes and provide an additional parameter that could be tuned in order to produce higher quality explanations. In some embodiments, policy distance calculator 306 generates a Kullback-Leibler divergence metric.

Scorer 308 calculates other scores and metrics upon processing the distance metrics generated by distance calculator 306. Such scores and metrics may be provided to facilitate understanding and explainability of the impact of perturbing certain factors. In one example, scorer 308 generates a metric reflective of a magnitude in change of aggressiveness metric of an automated agent 200.

An aggressiveness metric measures a level of aggressiveness in the policy of an automated agent 200. The aggressiveness metric can be implemented to include a weighted sum across available actions, with weights assigned based on the aggression level attributed to each action. In one example, a low level of aggression may be attributed to an action that does nothing while a high level of aggression may be attributed to an action that crosses the spread.

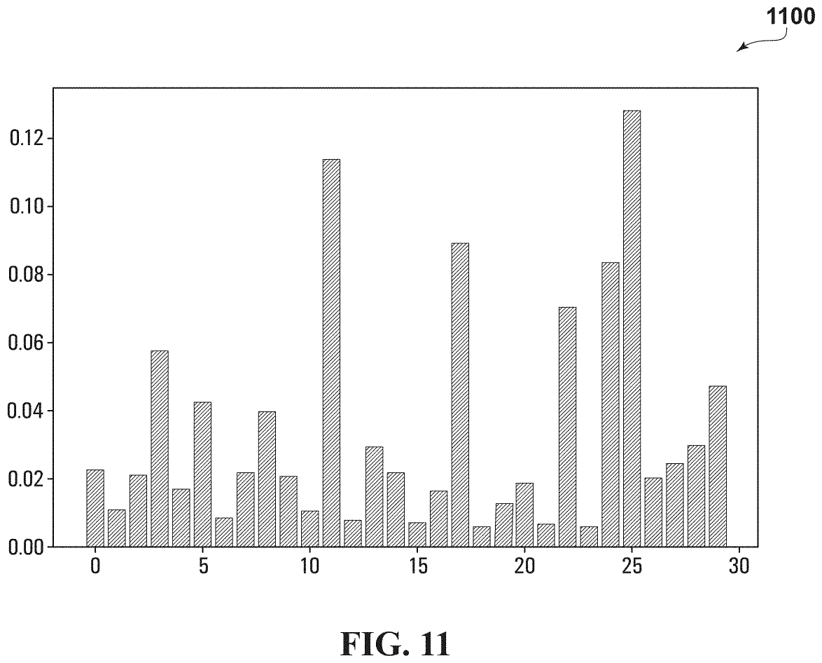

Output visualizer 310 generates a graphical representation including one or more distance metrics generated by policy distance calculator 306, or one or more other metrics or scores generated by scorer 308. Generated graphical representations may be displayed, for example, via interface application 130. FIG. 11 is an example graphical representation 1100 which shows the relative importance of thirty factors. In this graph, the x-axis represents factor numbers (from zero to twenty-nine), and y-axis represents the relative importance of the factors.

In particular, a greater y-axis value means changing the factor results in a greater change in an automated agent's policy.

In some embodiments, explainability subsystem 300 includes a state variable grouper 314. Grouper 314 generates a group definition data structure and provides this data structure to input generator 304. Grouper 314 identifies groups of related state variables. Identifying related state variables may include calculating pairwise correlations between state variables. Calculating pairwise correlation between state variables may include calculating co-variance between state variables. Various computations may be used, depending for example, on whether state variables are continuous or categorical. Example computations may include, for example, a Pearson's correlation, a Spearman's correlation, an F-Test, a T-Test, a Kruskal-Wallis, a Mann-Whitney U Test, and a X² Test, or the like.

In some embodiments, grouper 314 identifies groups of related state variables by performing hierarchical clustering. For example, in some embodiments, grouper 314 may implement a bottom-up or agglomerative clustering approach with the number of initial clusters equal to the total number of state variables. In accordance with this approach, the closest pair of clusters are merged at each iteration until a pre-defined criterion is reached (e.g., a desired number of clusters is reached). The approach may obtain a distance metric d to merge clusters where d=1−correlation (X, Y) for a pair of clusters X and Y. The approach may minimize a linkage metric when merging clusters where the linkage metric is the average of the pairwise distances of all state variables in two clusters. Other clustering approaches may also be used. For example, in some embodiments, grouper 314 may implement a top-down or divisive clustering approach with the initial cluster including all state variables.

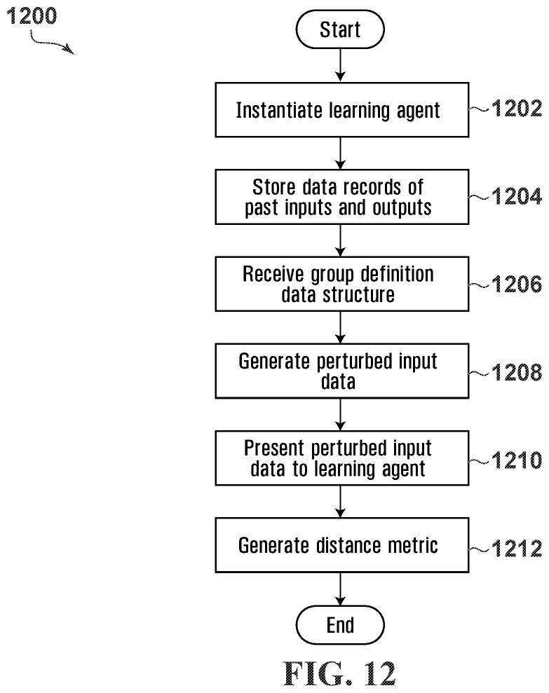

The operation of learning system 100 is further described with reference to the flowchart depicted in FIG. 12. System 100 performs the example operations depicted at blocks 1200 and onward, in accordance with an embodiment.

At block 1202, system 100 instantiates an automated agent 200 that generates, via a reinforcement learning neural network, policies governing its decision-making.

At block 1204, explainability subsystem 300 stores within database 302 data records of a plurality of past inputs presented to the automated agent, each of the past inputs including values of a plurality of state variables, and data records of a plurality of past policies, each of the past policies generated by the automated agent 200.

At block 1206, input generator 304 receives a group definition data structure defining a plurality of groups of the state variables. Each group may be a factor, as described herein.

At block 1208, for a given past input of the plurality of past inputs and a given group of plurality of groups of the state variables, input generator 304 generates data reflective of a perturbed input by altering a value of at least one state variable in the given group in the given past input.

At block 1210, input generator 304 presents the data reflective of the perturbed input to the automated agent 200 to obtain a perturbed policy generated by the automated agent.

At block 1212, policy distance calculator 306 generates a distance metric reflective of a magnitude of difference between the perturbed policy and the past policy.

Blocks 1208 and onward may be repeated for each of the plurality of groups. For example, generating perturbed input data, and calculating a distance metric may be repeated for each of the plurality of groups.

Blocks 1208 and onward may be repeated for each of the plurality of past inputs. For example, generating perturbed input data, and calculating distance metrics may be repeated for each of the past inputs.

It should be understood that steps of one or more of the blocks depicted in FIG. 12 may be performed in a different sequence or in an interleaved or iterative manner. Further, variations of the steps, omission or substitution of various steps, or additional steps may be considered.

Referring again the FIG. 1, aspects of system 100 are further described with an example embodiment in which system 100 is configured to function as a trading platform. In such embodiments, automated agent 200 may generate requests for to be performed in relation to securities, e.g., requests to trade, buy and/or sell securities.

Feature extraction unit 112 is configured to process input data to compute a variety of features. The input data can represent a trade order. Example features include pricing features, volume features, time features, Volume Weighted Average Price features, and market spread features.

Matching engine 114 is configured to implement a training exchange defined by liquidity, counter parties, market makers and exchange rules. The matching engine 114 can be a highly performant stock market simulation environment designed to provide rich datasets and ever changing experiences to reinforcement learning networks 110 (e.g. of agents 200) in order to accelerate and improve their learning. The processor 104 may be configured to provide a liquidity filter to process the received input data for provision to the machine engine 114, for example. In some embodiments, matching engine 114 may be implemented in manners substantially as described in U.S. patent application Ser. No. 16/423082, entitled “Trade platform with reinforcement learning network and matching engine”, filed May 27, 2019 the entire contents of which are hereby incorporated herein.

Scheduler 116 is configured to follow a historical Volume Weighted Average Price curve to control the reinforcement learning network 110 within schedule satisfaction bounds computed using order volume and order duration.

In some embodiments, an automated agent 200 may be trained by way of signals generated in accordance with reward system 126 to minimize Volume Weighted Average Price slippage. For example, reward system 126 may implement rewards and punishments substantially as described in U.S. patent application Ser. No. 16/426196, entitled “Trade platform with reinforcement learning”, filed May 30, 2019, the entire contents of which are hereby incorporated by reference herein.

In some embodiments, system 100 may process trade orders using the reinforcement learning network 110 in response to requests from an automated agent 200.

Some embodiments can be configured to function as a trading platform. In such embodiments, an automated agent 200 may generate requests to be performed in relation to securities, e.g., requests to trade, buy and/or sell securities.

Example embodiments can provide users with visually rich, contextualized explanations of the behaviour of an automated agent 200, where such behaviour includes requests generated by automated agents 200, decision made by automated agent 200, recommendations made by automated agent 200, or other actions taken by automated agent 200. Insights may be generated upon processing data reflective of, for example, market conditions, changes in policy of an automated agent 200, data outputted by scorer 308 describing the relative importance of certain factors or certain state variables.

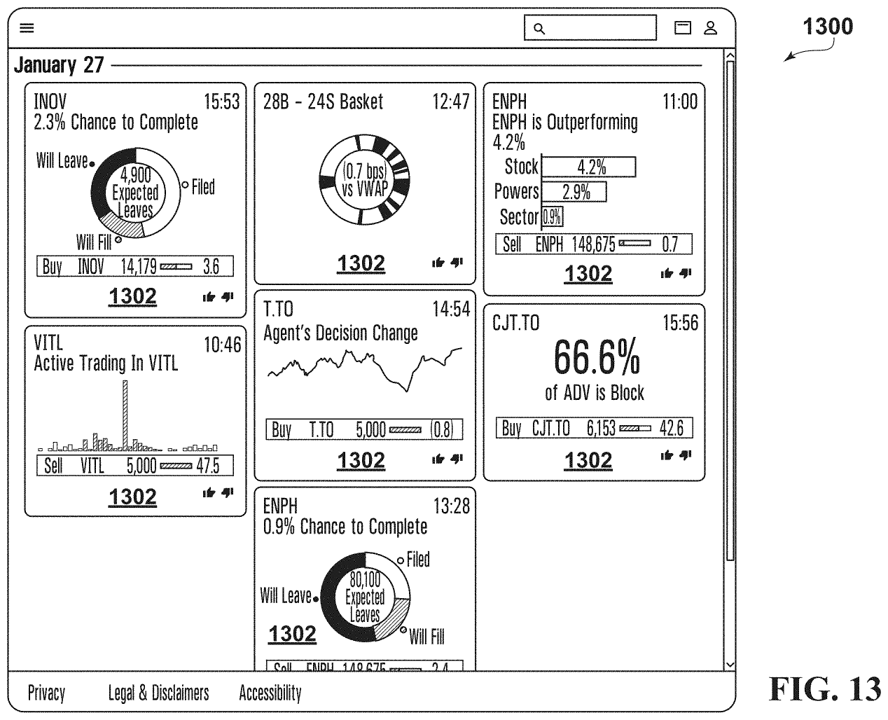

FIG. 13 depicts an example user interface (UI) 1300 generated by output visualizer 310, according to an embodiment. UI 1300 may be generated to be suitable for delivery by way of a web platform, a mobile platform, interface application 130 (FIG. 1), or the like. As depicted, UI 1300 includes a plurality of insight panels 1302, each presenting a generated insight regarding the behaviour of an automated agent 200.

In some embodiments, insight panels 1302 are displayed to the user in real-time or near real-time as insights are generated. Insights may be generated as an automated agent 200 makes particular decisions or takes particular actions. Insights may be generated reflective of trends in the decision making or other behaviours of an automated agent 200. Insights may be provided in relation to, for example, the chance of completing a particular bid, the financial performance of a particular corporation, the trading activity of a particular stock, or the like.

In some embodiments, insight panels 1302 are displayed in reverse chronological order. For example, as each new insight panel 1302 is generated, it can be presented at the top left region of UI 1300, while other insight panels 1302 can be moved to the right and down in response. Users can scroll through UI 1300 to access further insight panels 1302, e.g., including insight panels 1302 presenting insights generated on previous days.

In some embodiments, before an insight panel 1302 is displayed, output visualizer 310 computes a relevancy score for the insight panel 1302 and selectively displays those insight panels 1302 with a relevancy score exceeding a pre-defined threshold. When a relevancy score for a particular insight panel 1302 exceeds this threshold, output visualizer 310 determines the insight panel 1302 to be sufficiently relevant for display to the user.

A relevancy score may be computed taking into account a variety of data inputs.

The data inputs may include, for example, data relating to the importance of a particular request (e.g., a request to trade a particular security). Such importance may, for example, be described numerically, e.g., in a range between 0 and 1 or another range. Such importance may, for example, be described for a particular user, e.g., based on an inputted preference of the particular user or characteristics of the particular user. Such importance may, for example, be described relative to a user's other requests. Such importance, may for example, take into account a monetary value associated with the request, e.g., the value of securities being traded.

The data inputs may also include, for example, data relating to the importance of a particular insight. Such importance may, for example, be described numerically, e.g., in a range between 0 and 1. Such importance may, for example, be described for a particular user, e.g., based on an inputted preference of the particular user or characteristics of the particular user. Such importance may, for example, take into account data reflective of the importance of certain factors or certain state variables, as determined by scorer 308. Such importance may, for example, take into account a distance metric as determined by scorer 308. Such importance may, for example, take into account data reflective of importance of particular types of insight.

In some embodiments, a relevancy score can be computed as the product of a Request Score and an Insight Score, where Request Score has a numerical value proportional to importance of a particular request (e.g., an order in which case the Request Score may be referred to as an Order Score) and Insight Score has a numerical value proportional to importance of a particular insight.

In some embodiments, an insight can be evaluated for selective display via UI 1300 using the expression:

Request Score*Insight Score≥Threshold ∈E [0, 1]

In some cases, the value of Threshold may be set for all users. In some cases, the value of Threshold may be set for a particular user. In some cases, the value of Threshold may be set for a particular type of insight.

An insight is selected for display if the above expression has a value of 1, and is not selected for display if the expression has a value of 0. If an insight is selected for display, then a corresponding insight panel 1302 is generated and presented via UI 1300.

In some embodiments, UI 1300 is configured to allow a user to select a particular insight panel 1302 (e.g., through a click, tap, touch, or select or other action). This causes UI 1300 to display a further UI element which provides more information regarding the behaviour of an automated agent 200.

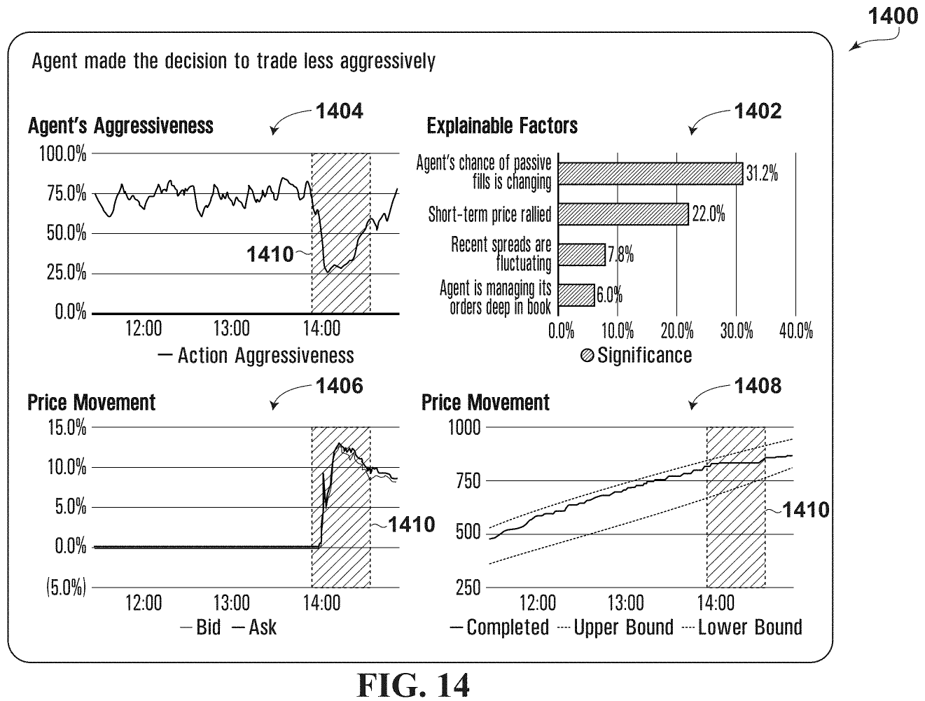

FIG. 14 depicts an example UI element, namely, an expanded panel 1400 that is displayed when a user selects an insight panel 1302, in accordance with an embodiment.

As depicted, expanded panel 1400 includes a plurality of UI regions arranged for efficient presentation of related information. For example, the UI regions are may be arranged into quadrants and this arrangement enables information across quadrants to be juxtaposed and readily integrated.

These UI regions include a region 1402 that shows a plurality of explainability factors sorted by their relevance to a particular insight subject of the selected insight panel 1302. In some embodiments, region 1402 may include only those explainability factors that are relatively more important to the decision-making of an automated agent 200 in relation to the particular insight, e.g., as indicated in the distance metrics provided by scorer 308. For example, a pre-defined number of the most important explainability factors may be included. In some embodiments, the explainability factors can be displayed in association with scores reflective of the importance of each factor. In some embodiments, the scores may be as determined by scorer 308. In some embodiments, the scores may be normalized scores, e.g., to be expressed as a percentage contribution to the decision-making of an automated agent 200.

In some embodiments, an explainability factor can be displayed using a text label mapped to the explainability factor, which provides a human-understandable description of the importance of the factor.

As depicted, the UI regions of expanded panel 1400 also include a region 1404 that shows the aggressiveness level of an automated agent 200 over a time period, a region 1406 that shows price movement over the time period of a security that is subject of decision-making by the automated agent 200, and a region 1408 that shows an execution summary over the time period. In some embodiments, the time period may be a pre-defined time period (e.g., 1 hour, 2 hours, 8 hours or the like). In some embodiments, the time period may be set based on the particular insight being presented.

In some embodiments, system 100 can evaluate multiple decisions of an automated agent 200 spanning an interval of time to generate insights. This can bring transparency to broader behavioral themes exhibited by automated agents 200, according to such embodiments.

In some embodiments, as an automated agent 200 generates requests over a time period (e.g., throughout a day) system 100 records and intermittently evaluates the policy distribution of the automated agent 200 using an exponentially-weighted rolling window. KL-divergence can be used to compare this intra-order average distribution to each new decision. This comparison can be made in real-time or near real-time. When a difference exceeding a pre-defined threshold is detected, an interval of dynamic length can be determined based on the KL-divergence and heuristics including length of time and the automated agent 200's state-space (e.g., how much room the agent currently has to operate within its discretion bounds).

Such an interval can be displayed in expanded panel 1400 as a time interval 1410 in one or more of regions 1404, 1406, and 1408. In some embodiments, the explainability factors in region 1402 are provided for decision-making over a time period corresponding to time interval 1410.

In some embodiments, the time interval 1410 may be user adjustable, e.g., by dragging the position of the time interval 1410 in UI 1100 or by selecting a new position for the time interval. In some embodiments, adjusting the position of time interval 1410 causes region 1402 to be automatically updated to reflect decision-making of an automated agent 200 for a selected time interval. In some embodiments, changing the position of time interval 1410 in one of regions 1404, 1406, or 1408 causes the time interval 1410 to be automatically adjusted to match in the other regions to facilitate automatic coordination of information across the regions.

In some embodiments, explainability subsystem 300 combines interval determination with single-decision agent perturbation to extend explainability to multiple consecutive decisions. In a given time interval, perturbation is applied to each decision and explanations are tallied to find one or more of the most important explanations over the interval. The most important explanations can be displayed to the users.

According to some embodiments, explainability subsystem 300 can generate a plurality of distance metrics comprising a plurality of distance metrics from past learned outputs generated within a time interval, evaluate a representative distance metric from the plurality of distance metrics, and generating a graphical representation of the representative distance metric using output visualizer 310.

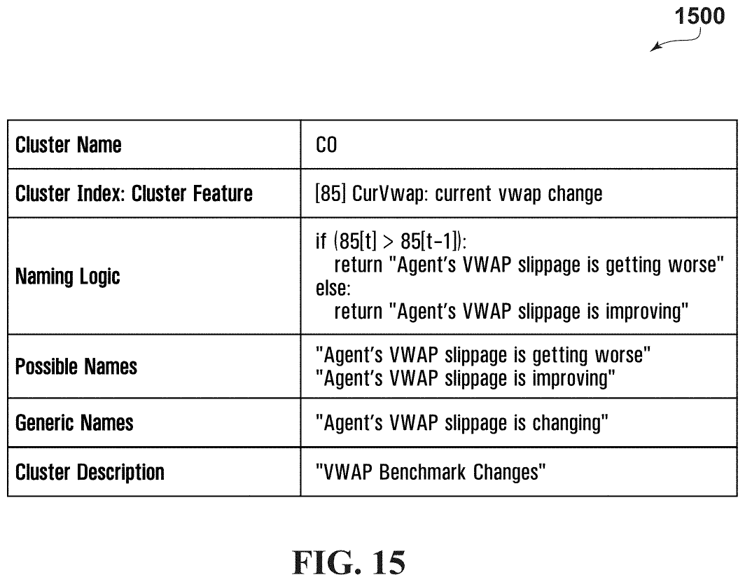

FIG. 15 depicts logic 1500 that can be used by explainability subsystem 300 to provide a human-understandable description of the importance of a factor, in accordance with an embodiment.

In some embodiments, the human-understandable description can be presented to the user via region 1402.

In some embodiments, explainability subsystem 300 implements “naming logic” shown in FIG. 15 to further evaluate the context of the environment or market in which a decision was made and provides a human-understandable description explanation of the importance of a factor. The logic can be used to map a detected importance of a factor into a human-understandable description of the importance.

For example, explainability subsystem 300 can evaluate a condition associated with one or more factors. The graphical representation, displayed by output visualizer 310, is based in part on the evaluated condition.

For example in FIG. 15, VWAP slippage is represented by factor (cluster) index [85] having a factor name C0 and a factor description “VWAP Benchmark Changes”. In this example, if VWAP slippage is greater at time interval t than it was in the previous time interval t-1, output visualizer 310 will present the text “Agent's VWAP slippage is getting worse” in region 1202. If VWAP slippage is not greater at time interval t than it was in the previous time interval t-1, output visualizer 310 will present the text “Agent's VWAP slippage is improving”. Output visualizer 310 may also use a “generic name” as shown in FIG. 15 if any context data for implementing the above described naming logic is not available. Output visualizer 310 may also use a “generic name” for the sake of computational efficiency.

Logic such as that illustrated in FIG. 15 can be implemented for one or more factors. In some cases, the logic for a particular factor may include a plurality of logic conditions. In some cases, the logic may also be implemented with conditional clauses that are determined by more than one factor. In some cases, the logic may be applied to values of particular state variables in a factor.

In the foregoing, example embodiments have been described in which automated agents 200 generate policies that govern their decision-making. However, in other embodiments, automated agents may generate a different type of learned output, including, for example, a value function output.

In the foregoing, example embodiments have been described in which automated agents 200 implement a reinforcement learning neural network to generate outputs that govern their decision-making. However, in other embodiments, automated agents 200 may implement a different type of neural network, including, for example, so-called shallow neural networks. In yet other embodiments, automated agents 200 may implement other function approximation representations, including, for example, a tabular function approximation representation or a tile-coding function approximation representation.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A computer-implemented system for facilitating explainability of decision-making by reinforcement learning agents, the system comprising:
at least one processor;
memory in communication with the at least one processor;
software code stored in the memory, which when executed at the at least one processor causes the system to:
instantiate a reinforcement learning agent that generates, via a function approximation representation, learned outputs governing its decision-making;
store data records of a plurality of past inputs presented to the reinforcement learning agent, each of the past inputs including values of a plurality of state variables, and data records of a plurality of past learned outputs, each of the past learned outputs generated by the reinforcement learning agent when presented with a corresponding one of the past inputs;
receive a group definition data structure defining a plurality of groups of the state variables; and
for a given past input of the plurality of past inputs and a given group of plurality of groups of the state variables:
generate data reflective of a perturbed input by altering a value of at least one state variable in the given group in the given past input;
present the data reflective of the perturbed input to the reinforcement learning agent to obtain a perturbed learned output generated by the reinforcement learning agent; and
generate a distance metric reflective of a magnitude of difference between the perturbed learned output and the past learned output.

2. The computer-implemented system of claim 1, wherein the software code, when executed at the at least one processor, further causes the system to:
generate a graphical representation including the distance metric.

3. The computer-implemented system of claim 2, wherein the software code, when executed at the at least one processor, further causes the system to:
evaluate a condition associated with one or more of the groups of state variables; and
wherein the graphical representation is based in part on the evaluated condition.

4. The computer-implemented system of claim 1, wherein the software code, when executed at the at least one processor, further causes the system to generate a human-understandable description of an importance of a given group based on the distance metric.

5. The computer-implemented system of claim 1, wherein the software code, when executed at the at least one processor, further causes the system to present a generated insight regarding a behaviour of the reinforcement learning agent.

6. The computer-implemented system of claim 1, wherein the software code, when executed at the at least one processor, further causes the system to:
repeat said generating for each of the plurality of past inputs.

7. The computer-implemented system of claim 1, wherein the software code, when executed at the at least one processor, further causes the system to:
repeat said generating for each of the groups of the state variables.

8. The computer-implemented system of claim 1, wherein the software code, when executed at the at least one processor, further causes the system to:
generate the group definition data structure upon calculating at least one correlation between the state variables.

9. The computer-implemented system of claim 1, wherein the software code, when executed at the at least one processor, further causes the system to:
generate a metric reflective of a magnitude in change of aggressiveness of the reinforcement learning agent, upon processing the distance metric.

10. The computer-implemented system of claim 1, wherein the generating the distance metric includes calculating an alpha-divergence.

11. The computer-implemented system of claim 1, wherein the function approximation representation includes at least one of a neural network, a tabular function approximation representation and a tile-coding function approximation representation.

12. The computer-implemented system of claim 1, wherein said plurality of past learned outputs includes a plurality of policies.

13. The computer-implemented system of claim 1, wherein said plurality of past learned outputs includes a plurality of value function outputs.

14. The computer-implemented system of claim 1, wherein said altering includes altering the value of the at least one state variable to a default value.

15. A computer-implemented method for facilitating explainability of decision-making by reinforcement learning agents, the method comprising:
instantiating a reinforcement learning agent that generates, via a function approximation representation, learned outputs governing its decision-making;
storing data records of a plurality of past inputs presented to the reinforcement learning agent, each of the past inputs including values of a plurality of state variables, and data records of a plurality of past learned outputs, each of the past learned outputs generated by the reinforcement learning agent when presented with a corresponding one of the past inputs;
receiving a group definition data structure defining a plurality of groups of the state variables; and
for a given past input of the plurality of past inputs and a given group of plurality of groups of the state variables:
generating data reflective of a perturbed input by altering a value of at least one state variable in the given group in the given past input;
presenting the data reflective of the perturbed input to the reinforcement learning agent to obtain a perturbed learned output generated by the reinforcement learning agent; and
generating a distance metric reflective of a magnitude of difference between the perturbed learned output and the past learned output.

16. The method of claim 15, further comprising generating a graphical representation including the distance metric.

17. The method of claim 15, further comprising repeating the generating the distance metric for each of the plurality of past inputs.

18. The method of claim 15, further comprising repeating the generating the distance metric for each of the groups of the state variables.

19. The method of claim 15, further comprising generating the group definition data structure upon calculating at least one correlation between the state variables.

20. The method of claim 15, further comprising generating a metric reflective of a magnitude in change of aggressiveness of the reinforcement learning agent, upon processing the distance metric.

21. The method of claim 15, wherein the generating the distance metric includes calculating an alpha-divergence.

22. The method of claim 15, wherein the function approximation representation includes at least one of a neural network, a tabular function approximation representation, and a tile-coding function approximation representation.

23. The method of claim 15, wherein said plurality of past learned outputs includes a plurality of policies.

24. The method of claim 15, wherein said plurality of past learned outputs includes a plurality of value function outputs.
